(19) United States
(12) Patent Application Publication
(10) Pub. No.: US 2014/0215320 A1
(43) Pub. Date: Jul. 31, 2014

(54) MARKER PLACEMENT SUPPORT APPARATUS, MARKER PLACEMENT SUPPORT METHOD, AND NON-TRANSITORY COMPUTER READABLE MEDIUM

(71) Applicant: FUJI XEROX CO., LTD., Tokyo (JP)

(72) Inventors: Kenichiro FUKUDA, Kanagawa (JP); Shinpei NODA, Kanagawa (JP); Yuichi ONEDA, Kanagawa (JP)

(21) Appl. No.: 13/943,027

(22) Filed: Jul. 16, 2013

(30) Foreign Application Priority Data
Jan. 25, 2013 (JP) 2013-012239

(51) Int. Cl. G06F 17/21

(52) U.S. Cl. CPC G06F 17/212
USPC 715/243

(57) ABSTRACT

A marker placement support apparatus includes an acquiring unit, a generating unit, and an output unit. The acquiring unit acquires image feature information included in a target image on which a marker of a specified size is to be placed. The generating unit generates, in accordance with image feature information included in an area of the target image in which a marker of a specified size is to be placed, display information indicating an area suitable for placing the marker on the target image. The output unit outputs the display information so that the display information is displayed while being superposed on the target image.

### CROSS-REFERENCE TO RELATED APPLICATIONS

This application is based on and claims priority under 35 USC 119 from Japanese Patent Application No. 2013-012239 filed Jan. 25, 2013.

### BACKGROUND

1. Technical Field

The present invention relates to a marker placement support apparatus, a marker placement support method, and a non-transitory computer readable medium.

2. Summary

According to an aspect of the invention, there is provided a marker placement support apparatus including an acquiring unit, a generating unit, and an output unit. The acquiring unit acquires image feature information included in a target image on which a marker of a specified size is to be placed. The generating unit generates, in accordance with image feature information included in an area of the target image in which a marker of a specified size is to be placed, display information indicating an area suitable for placing the marker on the target image. The output unit outputs the display information so that the display information is displayed while being superposed on the target image.

### BRIEF DESCRIPTION OF THE DRAWINGS

An exemplary embodiment of the present invention will be described in detail based on the following figures, wherein:

FIG. 1 illustrates the configuration of an information processing system according to an exemplary embodiment;

FIG. 2 illustrates an example of a marker setting screen;

FIG. 3 illustrates an example of the marker setting screen;

FIG. 4 illustrates an example of the marker setting screen;

FIG. 5 illustrates an example of the marker setting screen;

FIG. 6 illustrates an example of the marker setting screen;

FIG. 7 illustrates an example of the hardware configurations of a client apparatus, an information registration support server, and an information management server;

FIG. 8 is a diagram illustrating an example of a marker information management table;

FIG. 9 is a sequence diagram illustrating an example of a marker information registration process;

FIG. 10 is a flowchart illustrating an example of a process of generating marker placement support information; and

FIG. 11 is a sequence diagram illustrating an example of a process of providing marker-related information.

### DETAILED DESCRIPTION

Hereinafter, an exemplary embodiment of the present invention will be described with reference to the drawings.

### 1. Configuration of System

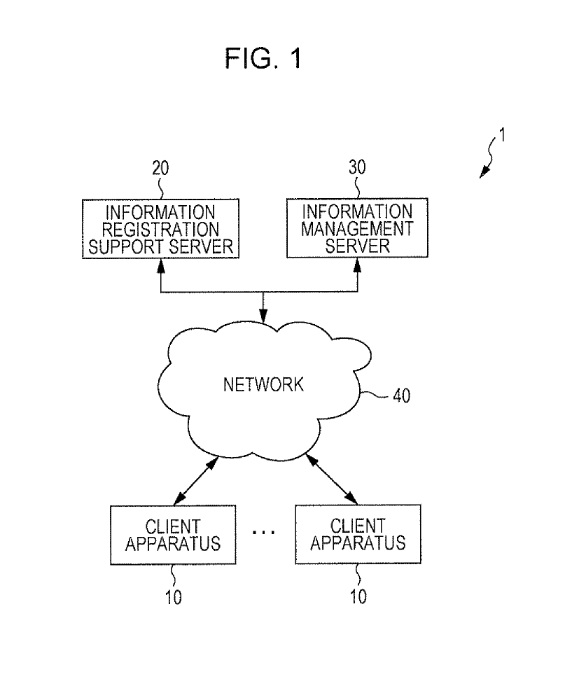

FIG. 1 illustrates the configuration of an information processing system 1 according to the exemplary embodiment. As illustrated in FIG. 1, the information processing system 1 includes one or more client apparatuses 10, an information registration support server 20, and an information management server 30, which are connected to one another so that they are capable of performing data communication with one another via a network 40. The information registration support server 20 and the information management server 30 may communicate with each other via a local area network.

### 1-1. Description of Outline

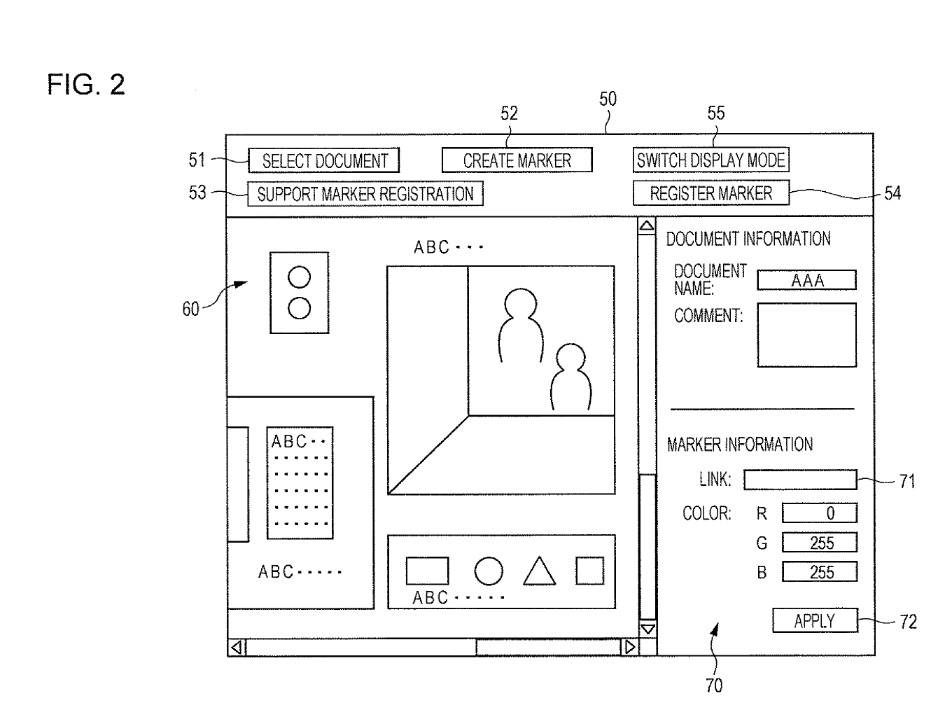

First, an outline of a process performed in the information processing system 1 according to the exemplary embodiment will be described with reference to FIGS. 2 to 6, which illustrate transition of screens.

As illustrated in FIG. 2, the client apparatus 10 displays a marker setting screen 50. On the marker setting screen 50, upon a “select document” button 51 being pressed and a target document to be registered (hereinafter simply referred to as “target document” as appropriate) being selected, the selected target document is displayed in a document display area 60. Also, attribute information about the target document is displayed in an attribute information display area 70.

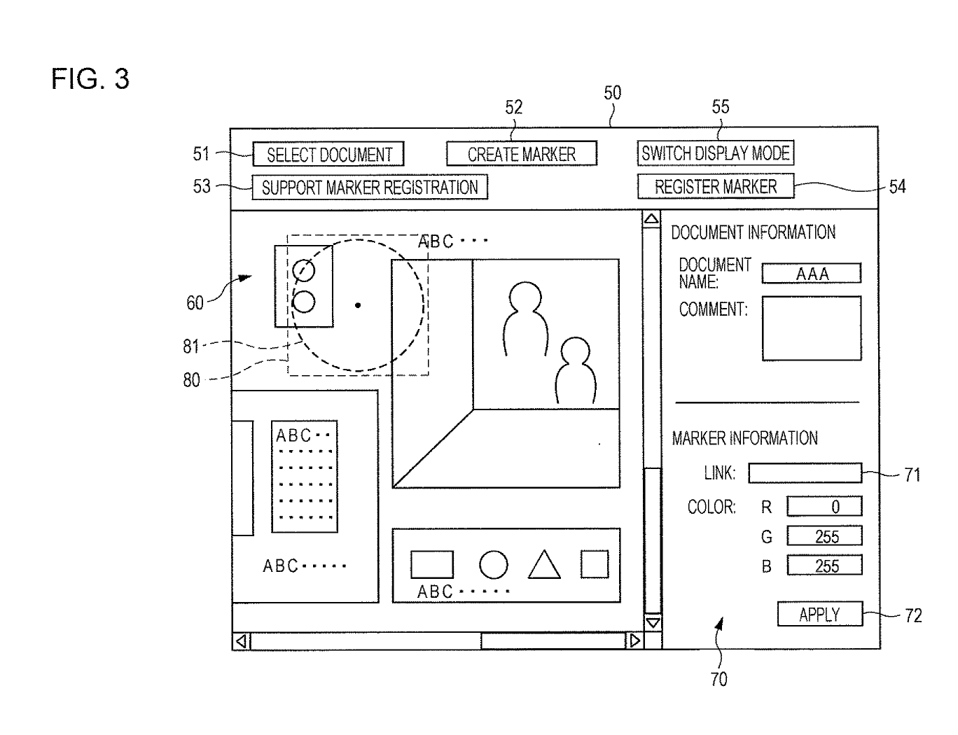

Upon a “create marker” button 52 on the marker setting screen 50 being pressed, a marker 81 and a marker placement area 80, which is a circumscribed rectangle of the marker 81, are displayed in the document display area 60, as illustrated in FIG. 3. Then, upon a “support marker registration” button 53 being pressed after a user has changed the size of the marker 81 to a desired size, the client apparatus 10 transmits the target document and information about the size of the marker to the information registration support server 20.

The information registration support server 20 evaluates, for each area of the target document, the degree of suitability as a marker placement area, on the basis of a distribution of image features (for example, feature points extracted from an image) included in the target document, generates marker placement support information that enables a user to at least determine whether each area is suitable as a marker placement area or not, and supplies the marker placement support information to the client apparatus 10.

Upon acquiring the marker placement support information from the information registration support server 20, the client apparatus 10 displays the marker placement support information by superposing it on the target document.

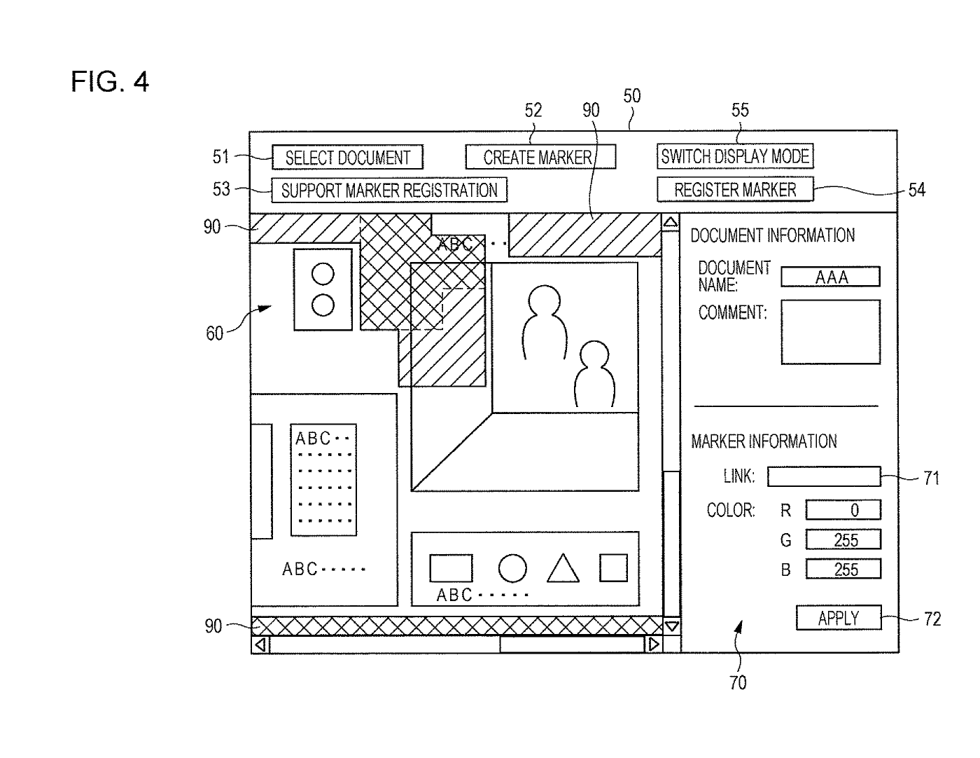

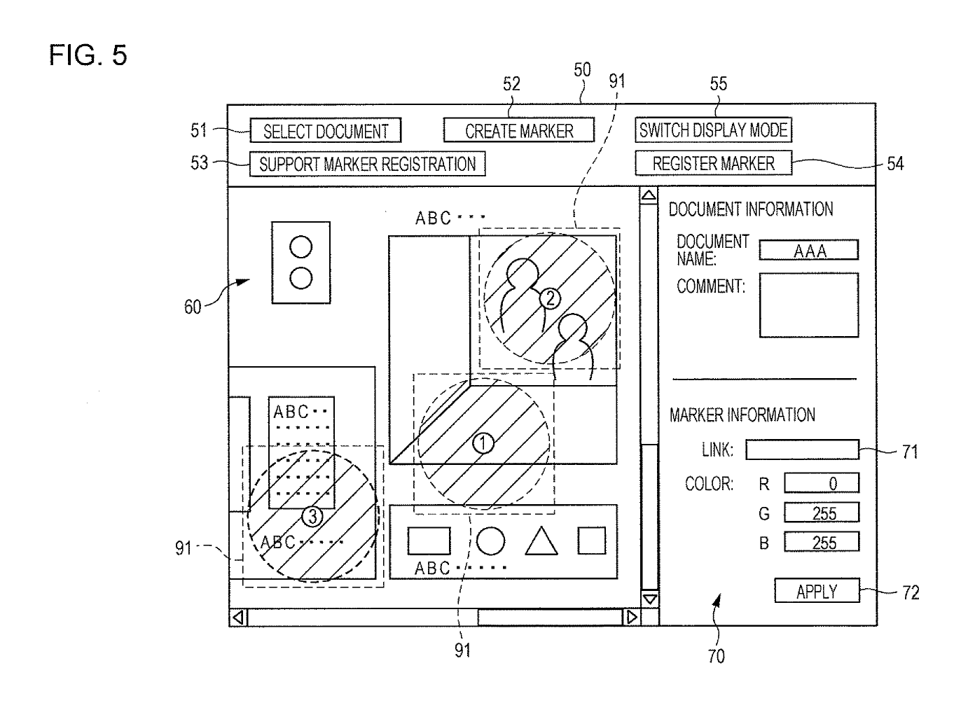

FIGS. 4 and 5 illustrate examples in which a target document to be registered and marker placement support information are displayed in a superposing manner.

In the example illustrated in FIG. 4, marker placement support information represents classification of areas according to the degree of suitability of marker placement. In FIG. 4, a hatched area 90 is an area of low suitability, and a non-hatched area is an area of high suitability (that is, the possibility of marker placement is high). In the example illustrated in FIG. 4, the degree of suitability decreases as the density of hatching increases, but the manner of displaying areas is not limited thereto.

In the example illustrated in FIG. 5, marker placement support information represents candidate areas that may be suitable for placing a marker. In the example illustrated in FIG. 5, first to third candidate areas 91 are displayed.

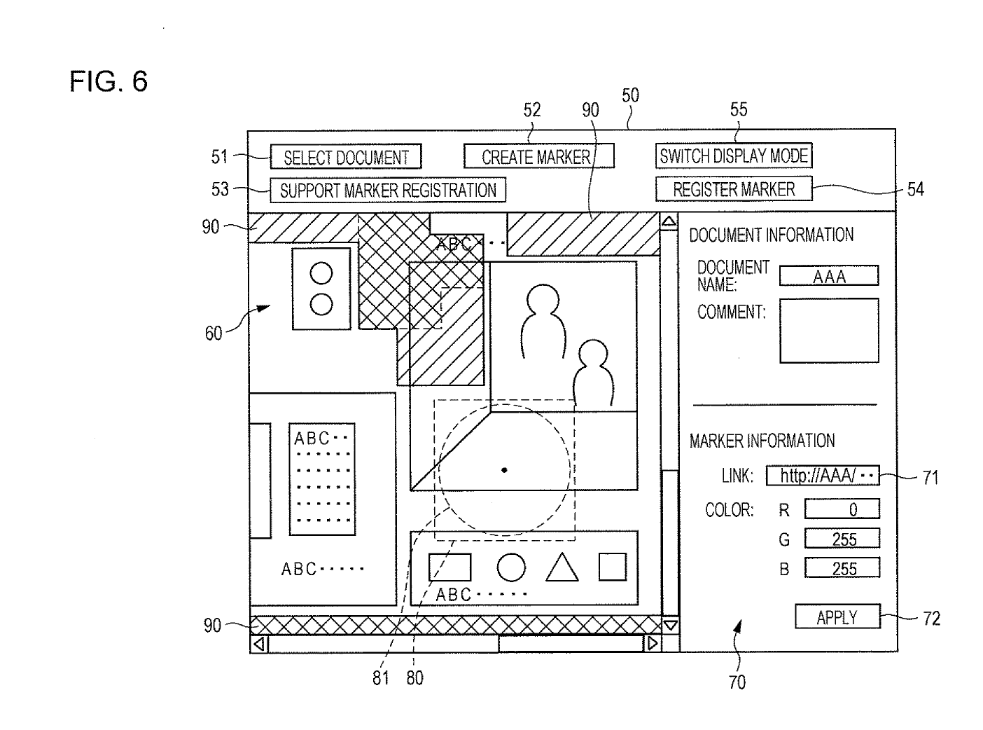

FIG. 6 illustrates an example in which the position of a marker is changed on the marker setting screen 50 illustrated in FIG. 4. In the example illustrated in FIG. 6, the position of the marker is changed so that the marker does not overlap the hatched areas 90. On the marker setting screen 50 illustrated in FIG. 6, upon a “register marker” button 54 being pressed after a link associated with the marker is input to a link specification field 71, an “apply” button 72 is pressed, and the input is reflected, the client apparatus 10 transmits information about the marker placement area and the marker (link or the like) to the information registration support server 20. The information registration support server 20 registers information in the information management server 30 on the basis of the information about the marker placement area and the marker received from the client apparatus 10. As described above with reference to an example of transition of screens, the information registration support server 20 according to the exemplary embodiment supports an operation of placing a marker on a target document to be registered.

### 2. Hardware Configuration

Next, the configurations of the client apparatus 10, the information registration support server 20, and the information management server 30 for implementing the above-described process will be described.

### 2-1. Client Apparatus 10

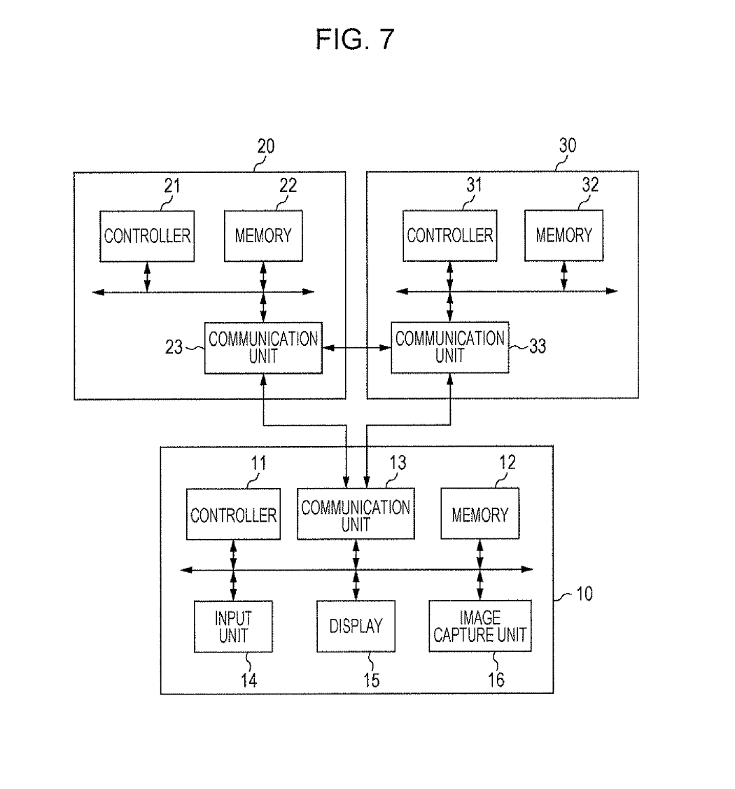

First, an example of the hardware configuration of the client apparatus 10 will be described. As illustrated in FIG. 7, the client apparatus 10 includes a controller 11, a memory 12, a communication unit 13, an input unit 14, a display 15, and an image capture unit 16.

The controller 11 includes a central processing unit (CPU), and executes various processing operations and controls individual units of the client apparatus 10 in accordance with a program stored in the memory 12.

The memory 12 stores a program of an operating system or the like of the client apparatus 10 and data (for example, document data), and is also used as a working memory of the controller 11. The program may be supplied to the client apparatus 10 by being stored in an information storage medium, such as an optical disc, a magnetic disk, a magnetic tape, a magneto-optical disc, or a flash memory, or may be supplied to the client apparatus 10 via a data communication medium, such as the Internet.

The communication unit 13 includes, for example, a network interface card, and communicates with the information registration support server 20 and the information management server 30 that are connected to the network 40, via the network interface card.

The input unit 14 includes input devices, such as a touch panel and a keyboard, and accepts input of an operation from a user.

The display 15 includes a display device, such as a liquid crystal display, and displays a result (screen) of information processing performed by the controller 11.

The image capture unit 16 includes a camera that is built in or externally attached to the client apparatus 10, and acquires a captured image, which is obtained by capturing an image of a subject by using the camera.

### 2-2. Information Registration Support Server 20

Next, an example of the hardware configuration of the information registration support server 20 will be described. As illustrated in FIG. 7, the information registration support server 20 includes a controller 21, a memory 22, and a communication unit 23.

The controller 21 includes a CPU, and executes various processing operations and controls individual units of the information registration support server 20 in accordance with a program stored in the memory 22.

The memory 22 stores a program of an operating system or the like of the information registration support server 20 and data, and is also used as a working memory of the controller 21. The program may be supplied to the information registration support server 20 by being stored in an information storage medium, such as an optical disc, a magnetic disk, a magnetic tape, a magneto-optical disc, or a flash memory, or may be supplied to the information registration support server 20 via a data communication medium, such as the Internet.

The communication unit 23 includes a network interface card, and performs data communication with the client apparatuses 10 connected to the network 40 and performs data communication with the information management server 30 connected to a local network or the network 40, via the network interface card.

### 2-3. Information Management Server 30

Next, an example of the hardware configuration of the information management server 30 will be described. As illustrated in FIG. 7, the information management server 30 includes a controller 31, a memory 32, and a communication unit 33.

The controller 31 includes a CPU, and executes various processing operations and controls individual units of the information management server 30 in accordance with a program stored in the memory 32.

The memory 32 stores a program of an operating system or the like of the information management server 30 and data, and is also used as a working memory of the controller 31. The program may be supplied to the information management server 30 by being stored in an information storage medium, such as an optical disc, a magnetic disk, a magnetic tape, a magneto-optical disc, or a flash memory, or may be supplied to the information management server 30 via a data communication medium, such as the Internet. Hereinafter, an example of data stored in the memory 32 will be described.

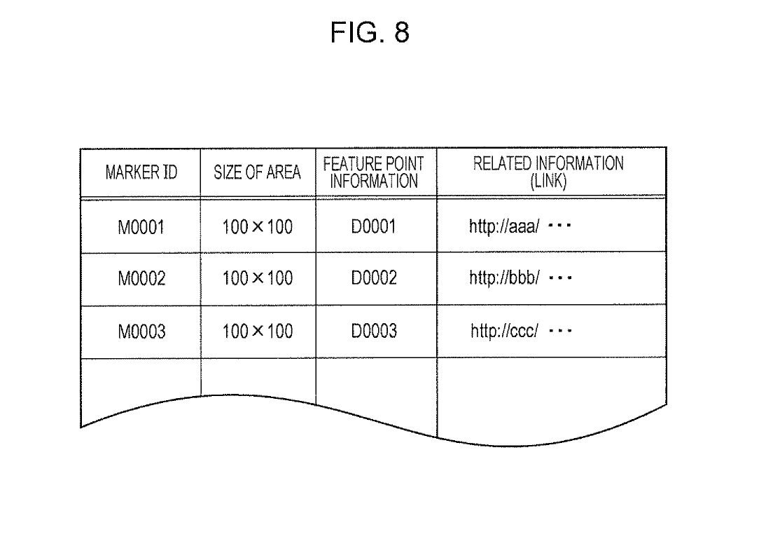

The memory 32 stores, for example, a marker information management table. FIG. 8 illustrates an example of the marker information management table. As illustrated in FIG. 8, the marker information management table stores marker IDs that identify markers, the sizes of areas where markers are placed, feature point information based on feature point information in marker placement areas, and related information associated with markers (for example, links), which are associated with one another.

The communication unit 33 includes a network interface card, and performs data communication with the client apparatuses 10 connected to the network 40 and performs data communication with the information registration support server 20 connected to a local network or the network 40, via the network interface card.

### 3. Sequence

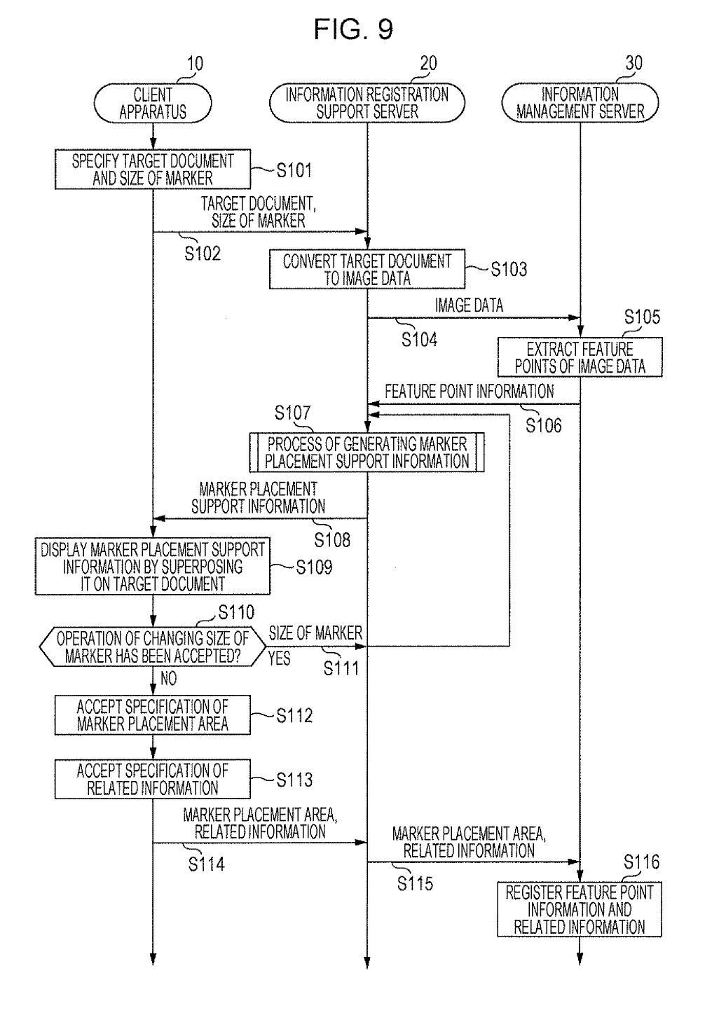

Next, the details of a process performed by the individual apparatuses included in the information processing system 1 will be described with reference to the sequence diagrams and the flowchart illustrated in FIGS. 9 to 11. In the process described below, an image feature of an image area is generated as a feature quantity that is based on feature points extracted using, for example, a scale-invariant feature transform (SIFT) algorithm. Of course, an image feature of an image area may be generated on the basis of another method, for example, the ratio of an amount of specific spatial frequency components in the image area to an amount of other spatial frequency components in the image area, an amount of edge, or the total sum of absolute values of differences between adjacent pixel values.

### 3-1. Marker Information Registration Process

First, description will be given of the details of a process performed by the client apparatus 10, the information registration support server 20, and the information management server 30 when information about a marker is to be registered (marker information registration process), with reference to FIG. 9.

As illustrated in FIG. 9, in step S101, the client apparatus 10 accepts, from a user, specification of a target page of a target document to be registered whose information is to be registered, and specification of the size of a marker indicating that related information is added in the target document. Here, the client apparatus 10 may accept specification of a desired position where a marker is to be placed, together with specification of the size of the marker. For example, specification of the target document, the target page, and the size of the marker may be accepted on the marker setting screen 50 illustrated in FIG. 2.

In step S102, the client apparatus 10 transmits the target document (including at least the target page) and information about the size of the marker (and a desired position of the marker) specified in step S101 to the information registration support server 20.

The information registration support server 20 converts the target page of the target document, which has been received from the client apparatus 10, to image data in step S103, and transmits the image data to the information management server 30 in step S104.

The information management server 30 extracts feature points of the image data received from the information registration support server 20 in step S105, and transmits information about the extracted feature points to the information registration support server 20 in step S106. For example, information about the feature points may be information about the coordinates of positions of feature points in the image data.

In step S107, the information registration support server 20 generates marker placement support information on the basis of the information about feature points received from the information management server 30 and the information about the size of the marker (if there is a desired position of the marker, information thereof may also be included). The marker placement support information is display information indicating a coordinate area that is suitable or not suitable for placing a marker in the target document (image data), specifically, the suitability distribution display information illustrated in FIG. 4 or the candidate area information illustrated in FIG. 5. The details of a process of generating marker placement support information will be described below.

In step S108, the information registration support server 20 transmits the marker placement support information generated in step S107 to the client apparatus 10.

Upon receiving the marker placement support information from the information registration support server 20, the client apparatus 10 displays the marker placement support information by superposing it on the target document in step S109. The client apparatus 10 may switch between a mode of displaying marker placement support information by superposing it on a target document to be registered and a mode of displaying a target document to be registered alone, every time a “switch display mode” button 55 is pressed on the marker setting screen 50 illustrated in FIGS. 4 and 5.

If the client apparatus 10 accepts an operation of changing the size of the marker from the user (YES in step S110), the client apparatus 10 transmits information about the changed size of the marker to the information registration support server 20 in step S111.

Upon receiving the information about the changed size from the client apparatus 10, the information registration support server 20 returns to step S107, generates marker placement support information again on the basis of the changed size of the marker, and continues the process.

If the client apparatus 10 does not accept an operation of changing the size of the marker from the user (NO in step S110), accepts specification of a marker placement area in step S112, and accepts specification of related information associated with the marker (for example, link information) in step S113, the client apparatus 10 transmits information about the marker placement area and the related information to the information registration support server 20 in step S114.

Upon receiving the information about the marker placement area and the related information from the client apparatus 10, the information registration support server 20 transmits the received information about the marker placement area and the related information to the information management server 30, so as to request registration of the information in step S115.

Upon receiving the information about the marker placement area and the related information from the information registration support server 20, the information management server 30 registers information about feature points included in the marker placement area and the related information in the marker information management table in association with each other in step S116.

The description of an example sequence of the information registration process has been given above.

### 3-2. Process of Generating Marker Placement Support Information

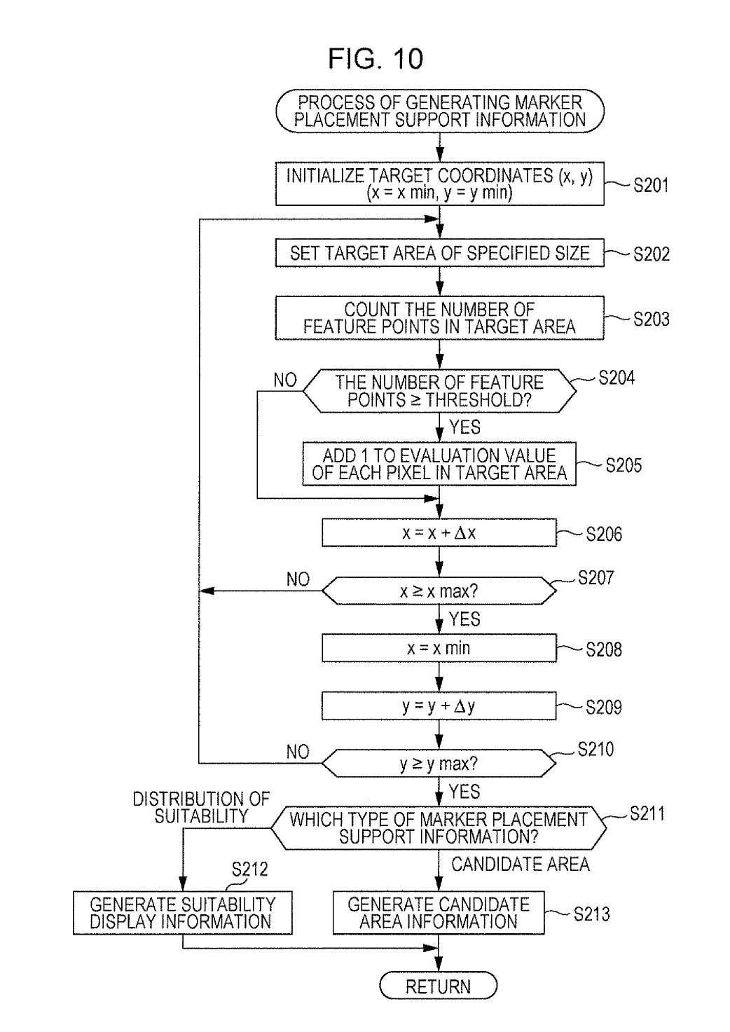

Next, the details of the process of generating marker placement support information that is performed in step S107 in the sequence illustrated in FIG. 9 will be described with reference to the flowchart illustrated in FIG. 10.

In the flowchart illustrated in FIG. 10, the horizontal axis of image data, which is obtained by converting a target document to be registered into an image, is regarded as an X-axis, and the vertical axis thereof is regarded as a Y-axis. Coordinates of the image data is represented by (x, y). Here, xmin≦x≦xmax, and ymin≦y≦ymax are satisfied.

As illustrated in FIG. 10, the information registration support server 20 first initializes target coordinates (x, y) in the image data as x=xmin and y=ymin in step S201.

Subsequently, in step S202, the information registration support server 20 sets a target area of a specified size in the image data, with the target coordinates being a base point. Here, the specified size is the (latest) size of the marker accepted from the client apparatus 10.

In step S203, the information registration support server 20 counts the number of feature points included in the target area that is set in step S202, on the basis of information about the coordinates of the feature points extracted from the image data by the information management server 30. If the number of feature points is larger than or equal to a threshold (YES in step S204), the information registration support server 20 adds 1 to the evaluation value of each pixel (the initial value of the evaluation value of each pixel=0) in the target area in step S205. In the case of using a feature quantity other than information about feature points in the target area as an image feature of the target area, if the amount of information of the image feature of the target area is larger than or equal to a threshold, 1 may be added to the evaluation value of each pixel in the target area.

After step S205, or if the number of feature points counted in step S203 does not reach the threshold (NO in step S204), the information registration support server 20 increases the x-coordinate of the target coordinates by Δx in step S206. Δx may be a fixed value, or may be changed (increased or decreased) in accordance with a request from the client apparatus 10.

If the x-coordinate updated in step S206 is not larger than or equal to xmax (maximum value) (NO in step S207), the information registration support server 20 returns to step S202. If the x-coordinate updated in step S206 is larger than or equal to xmax (maximum value) (YES in step S207), the information registration support server 20 initializes the x-coordinate of the target coordinates to xmin in step S208, and increases the y-coordinate of the target coordinates by Δy in step S209. Like Δx, Δy may be a fixed value, or may be changed (increased or decreased) in accordance with a request from the client apparatus 10.

If the y-coordinate updated in step S209 is not larger than or equal to ymax (maximum value) (NO in step S210), the information registration support server 20 returns to step S202. If the y-coordinate updated in step S209 is larger than or equal to ymax (maximum value) (YES in step S210), the information registration support server 20 proceeds to step S211.

If the type of marker placement support information is display information about a distribution of suitability (suitability display information) (distribution of suitability in step S211), the information registration support server 20 generates suitability display information on the basis of the evaluation value of each pixel of the image data in step S212. For example, the information registration support server 20 may determine the rank of each pixel by classifying each evaluation value to one of plural ranks, for example, rank A (THA≦evaluation value), rank B (THB≦evaluation value<THA), and rank C (evaluation value<THB). The information registration support server 20 may generate, as suitability display information, information for displaying each pixel of image data in a different form (color, hatching) in accordance with the rank. In the example of suitability display information illustrated in FIG. 4, rank A corresponds to non-hatching, rank B corresponds to light hatching, and rank C corresponds to dense hatching.

If the type of marker placement support information is display information about candidate areas (candidate area information) (candidate area in step S211), the information registration support server 20 generates candidate area information on the basis of the evaluation value of each pixel of the image data in step 6213. For example, the information registration support server 20 generates a distribution of suitability on the basis of the evaluation value of each pixel of the image data, and extracts areas in which the evaluation value in the generated distribution of suitability is a threshold or larger (for example, areas of rank A). Then, the information registration support server 20 may select one or more candidate areas where the marker of the specified size may be placed from among the extracted areas, and may generate information representing the selected candidate areas as candidate area information. In a case where the information registration support server 20 has accepted a desired position of the marker from the client apparatus 10, the information registration support server 20 may rank the selected candidate areas in ascending order of the distance to the desired position of the marker, and may generate candidate area information representing the candidate areas together with the ranks.

After finishing step S212 or S213, the information registration support server 20 ends the process of generating marker placement support information, and returns to the sequence illustrated in FIG. 9.

### 3-3. Process of Providing Marker-Related Information

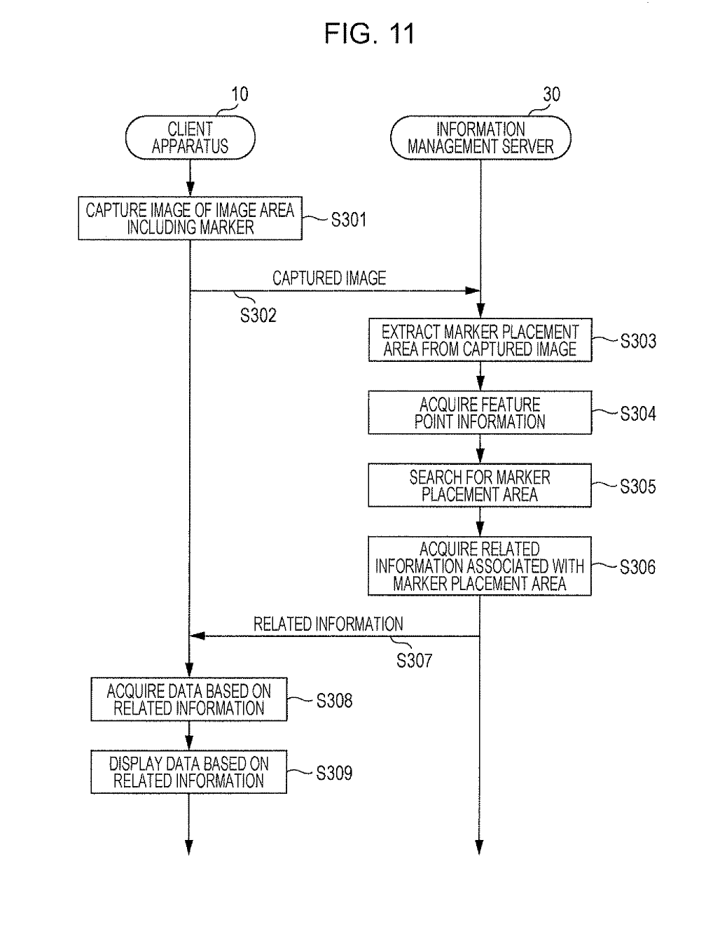

Next, a process of providing marker-related information to the client apparatus 10 using marker information registered in the information management server 30 will be described with reference to the sequence diagram illustrated in FIG. 11.

As illustrated in FIG. 11, the client apparatus 10 captures an image of an image area including a marker, which is included in a printing medium or the like, in step S301, and transmits the captured image to the information management server 30 in step S302.

Upon receiving the captured image from the client apparatus 10, the information management server 30 detects a marker from the captured image, and extracts a marker placement area that is based on the detected marker from the captured image in step S303. For example, the information management server 30 may extract a circumscribed rectangle of the marker as a marker placement area.

Subsequently, in step S304, the information management server 30 extracts feature points included in the marker placement area that is extracted in step S303 and acquires feature point information that is based on the coordinates of the feature points. In step S305, the information management server 30 searches the marker information management table for a marker placement area (marker ID) having corresponding feature point information, using the acquired feature point information as a key. For example, in a case where feature point information is generated as vector data of coordinates, the information management server 30 may search for feature point information in which the distance to the feature point information as a key is the minimum.

In step S306, the information management server 30 acquires, from the marker information management table, related information (link) associated with the marker placement area (marker ID) searched in step S305. In step S307, the information management server 30 transmits the acquired related information to the client apparatus 10.

The client apparatus 10 acquires data that is based on the related information received from the information management server 30 in step S308, and displays the acquired data in step S309. For example, if the related information is a link, the client apparatus 10 may display data acquired by accessing the link.

In the information processing system 1 according to the above-described exemplary embodiment, in the case of placing a marker on a target document to be registered, an area suitable as a marker placement area and an area unsuitable as a marker placement area are displayed on the target document in a distinguishable manner. Accordingly, a marker may be easily placed compared to a case where such display is not performed.

An embodiment of the present invention is not limited to the above-described exemplary embodiment. For example, the information registration support server 20 may generate both suitability display information and candidate area information and transmit them to the client apparatus 10, and may switch among a mode of superposition display based on suitability display information, a mode of superposition display based on candidate area information, and a mode in which superposition display is turned off, every time the display mode is switched. In a case where the client apparatus 10 has registered a target document on which a marker is placed, the client apparatus 10 may register the target document on which the marker is placed in the information management server 30.

In the above-described exemplary embodiment, the information registration support server 20 and the information management server 30 are configured as separate apparatuses, but the information registration support server 20 and the information management server 30 may be integrated together. The function of the information registration support server 20 may be loaded as an application that is operated in the client apparatus 10.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A marker placement support apparatus comprising:
an acquiring unit that acquires image feature information included in a target image on which a marker of a specified size is to be placed;
a generating unit that generates, in accordance with image feature information included in an area of the target image in which a marker of a specified size is to be placed, display information indicating an area suitable for placing the marker on the target image; and
an output unit that outputs the display information so that the display information is displayed while being superposed on the target image.

2. The marker placement support apparatus according to claim 1, further comprising:
an accepting unit that accepts specification of a placement area in which the marker is to be placed on the target image and specification of related information associated with the marker, and that causes a memory to store image feature information included in the placement area and the related information in association with each other.

3. The marker placement support apparatus according to claim 1,
wherein, if the size of the marker is changed, the generating unit regenerates the display information, and the output unit outputs the regenerated display information so that the regenerated display information is displayed while being superposed on the target, image.

4. The marker placement support apparatus according to claim 2,
wherein, if the size of the marker is changed, the generating unit regenerates the display information, and the output unit outputs the regenerated display information so that the regenerated display information is displayed while being superposed on the target image.

5. The marker placement support apparatus according to claim 1, further comprising:
an adding unit that adds, for each of areas that has the specified size and has a base point which corresponds to one of one or more positions included in the target image, a degree of suitability to the area if the amount of image feature information included in the area exceeds a threshold,
wherein the generating unit generates the display information in accordance with degrees of suitability of the individual areas of the target image.

6. The marker placement support apparatus according to claim 5,
wherein the generating unit generates the display information that at least indicates an area in which a degree of suitability does not satisfy a predetermined condition in the target image.

7. The marker placement support apparatus according to claim 5,
wherein the generating unit generates the display information that at least indicates an area in which a degree of suitability satisfies a predetermined condition in the target image and which has a size allowing placement of the marker.

8. A marker placement support apparatus comprising:
an acquiring unit that acquires feature points from a target image on which a marker is to be placed;
a generating unit that generates, in a case where a marker is to be placed on the target image, display information indicating whether or not the number of feature points included in a placement area of the marker exceeds a threshold;
an output unit that outputs the display information so that the display information is displayed while being superposed on the target image;
an accepting unit that accepts specification of a placement area in which the marker is to be placed on the target image and specification of a uniform resource locator associated with the marker, and that causes a memory to store information about feature points included in the placement area and the uniform resource locator in association with each other; and
a transmitting unit that, upon receiving a captured image, extracts feature points from the captured image, searches the memory for information about feature points similar to the extracted feature points, and transmits a uniform resource locator corresponding to the information to a transmitter of the captured image.

9. A marker placement support method comprising:
acquiring image feature information included in a target image on which a marker of a specified size is to be placed;
generating, in accordance with image feature information included in an area of the target image in which a marker of a specified size is to be placed, display information indicating an area suitable for placing the marker on the target image; and
outputting the display information so that the display information is displayed while being superposed on the target image.

10. A non-transitory computer readable medium storing a program causing a computer to execute a process, the process comprising:
acquiring image feature information included in a target image on which a marker of a specified size is to be placed;
generating, in accordance with image feature information included in an area of the target image in which a marker of a specified size is to be placed, display information indicating an area suitable for placing the marker on the target image; and
outputting the display information so that the display information is displayed while being superposed on the target image.
